(19) United States
(12) Patent Application Publication
(10) Pub. No.: US 2021/0189295 A1
(43) Pub. Date: Jun. 24, 2021

(54) ENZYME-CONTAINING GRANULES

(71) Applicant: DANISCO US INC, Palo Alto, CA (US)

(72) Inventors: Sander Bas KLUIT, LEIDEN (NL); Tero-Tapani TÄHTI, KIRKKONUMMI (FI)

(21) Appl. No.: 17/271,434

(22) PCT Filed: Aug. 29, 2019
(86) PCT No.: PCT/US2019/048749

§ 371 Date: Feb. 25, 2021

Related U.S. Application Data
(60) Provisional application No. 62/724,722, filed on Aug. 30, 2018.

(51) Int. Cl. C11D 3/386; C11D 17/00; C11D 3/12; C11D 3/37; C11D 3/40

(52) U.S. Cl. CPC C11D 3/386; C11D 17/0039; C11D 3/40; C11D 3/3753; C11D 3/3776; C11D 3/128

(57) ABSTRACT

Disclosed herein are enzyme-containing granules, and compositions and methods related to the production and use thereof, including enzyme-containing granules that have improved features compared to one or more reference granules.

The present compositions and methods relate to enzyme-containing granules. The granules are particularly useful in consumer and industrial products, such as detergent, animal feed, food, personal care and agricultural compositions.

### BACKGROUND

The use of proteins such as pharmaceutically important proteins, e.g., hormones, and industrially important proteins, e.g., enzymes, has continued to grow over the past decade. Today, for example, enzymes find frequent use in the starch, dairy, and detergent industries, among others.

In the detergent industry, in particular, enzymes are often configured in a granular form, with an eye toward achieving one or more desirable storage and/or performance characteristics, depending upon the particular application at hand. In these regards, the industry has offered numerous developments in the granulation and coating of enzymes.

Notwithstanding such developments, there is a continuing need for enzyme granules which have additional beneficial or improved characteristics.

### SUMMARY

One embodiment is directed to granules comprising a core and at least one layer, wherein the granule comprises at least one enzyme; and at least one pigment coating comprising between about 10%-30% of a water soluble polymer, between about 1%-10% of a nonionic surfactant, and between about 60%-90% of an aluminosilicate. In some embodiments, the enzyme for use in the granule is selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, lysozymes, mannanases, oxidases, pectate lyases, pectin acetyl esterases, pectinases, pentosanases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, metalloproteases, nucleases, serine proteases, and combinations thereof.

In certain embodiments, the water-soluble polymer is a polyvinyl polymer selected from the group consisting of PVP, PVA, and copolymers thereof. In some embodiments, the pigment coating comprises between about 15%-25% of a water soluble polymer. In some embodiments, the pigment coating comprises between about 5%-10% of a nonionic surfactant. In some embodiments, the nonionic surfactant is an alcohol ethoxylate. In some embodiments, the pigment coating comprises between about 60%-80% of an aluminosilicate. In some embodiments, the aluminosilicate is a zeolite or kaolin or a combination of a zeolite and kaolin. In some embodiments, the pigment layer does not comprise titanium dioxide.

Also provided herein are granules composition comprising, a core, an enzyme layer comprising at least one enzyme wherein the enzyme comprises between 10%-30% of the total granule composition; and a pigment layer surrounding the enzyme layer, wherein the pigment layer comprises a water soluble polymer, a nonionic surfactant, and a zeolite or kaolin, or a combination of zeolite and kaolin, wherein the zeolite or kaolin or combination of zeolite and kaolin comprises between 5%-20%, or 5%-15%, of the total granule composition, and where the granule has a Hunter color L-value of greater than 50. In some embodiments, the granule has a Hunter color L-value of between 60-80.

In some embodiments, the at least one enzyme is selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, lysozymes, mannanases, oxidases, pectate lyases, pectin acetyl esterases, pectinases, pentosanases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, metalloproteases, nucleases, serine proteases, and combinations thereof.

The disclosure also provides methods of cleaning a surface, the method comprising the steps of contacting a surface with a composition comprising a granule of the present disclosure; and rinsing the surface.

In some embodiments, the surface is selected from a fabric, dish, or hard surface.

The disclosure further provides methods of reducing the filming and/or spotting on dish surfaces washed in an automatic dishwasher comprising contacting the dishes with a dishwashing composition comprising an enzyme granule comprising a core; an enzyme layer comprising between 10%-30% of the total granule composition; and a pigment layer comprising a water soluble polymer, a nonionic surfactant, and an aluminosilicate, wherein the aluminosilicate comprises between 5%-10% of the total granule composition. In some embodiments, the granule has a Hunter color L-value of greater than 50.

In some embodiments, the surface contacted in the methods provided herein is selected from a dish or hard surface.

### DESCRIPTION OF THE FIGURES

FIG. 1 provides an example of the effects of one embodiment of the present invention compared to titanium dioxide-containing granules on film deposition on glass.

FIG. 2 provides an example of the effects of one embodiment of the present invention compared to titanium dioxide-containing granules on film deposition on a plastic cutting board.

FIG. 3 provides an example of the effects of one embodiment of the present invention compared to titanium dioxide-containing granules on film deposition on transparent glass tubes.

### DESCRIPTION

The present disclosure provides enzyme granules comprising a pigment layer having an aluminosilicate and compositions containing such granules. The present disclose also provides methods using such granules and compositions for cleaning surfaces and methods for reducing spotting or filming on surfaces, such as hard surfaces.

Prior to describing embodiments of present compositions and methods, the following terms are defined.

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, a “particulate enzyme powder” is a substantially solid composition that includes an enzyme and up to about 6% water (w/w).

As used herein, “cleaning compositions” and “cleaning formulations” refer to compositions that may be used for the removal of undesired compounds from items to be cleaned, such as fabric, dishes, contact lenses, other solid substrates, hair (shampoos), skin (soaps and creams), teeth (mouthwashes, toothpastes) etc. The term encompasses any materials/compounds selected for the particular type of cleaning composition desired. The specific selection of cleaning composition materials are readily made by considering the surface, item or fabric to be cleaned, and the desired form of the composition for the cleaning conditions during use.

As used herein, the terms “detergent composition” and “detergent formulation” are used in reference to mixtures which are intended for use in a wash medium for the cleaning of soiled objects. In some preferred embodiments, the term is used in reference to laundering fabrics and/or garments (e.g., “laundry detergents”). In alternative embodiments, the term refers to other detergents, such as those used to clean hard surfaces such as dishes, cutlery, etc. (e.g., “dishwashing detergents”).

As used herein, the term “hard surface” refers to any article having a hard surface including floors, tables, walls, roofs etc. as well as surfaces of hard objects such as cars (car wash), ship hulls, dishes (dishware), medical instruments, pipes, reservoirs, or holding tanks. The term “hard surface” includes also the surfaces of flexible yet firm objects such as the insides of bendable tubing and supply lines or the surfaces of deformable holding tanks or vessels. The term “hard surface” includes also the surfaces in the interior of washing machines, such as the interior of laundry washing machines or dishwashing machines, this includes soap intake box, walls, windows, baskets, racks, nozzles, pumps, sump, filters, pipelines, tubes, joints, seals, gaskets, fittings, impellers, drums, drains, traps, coin traps inlet and outlets. The term hard surface does not encompass textile or fabric.

As used herein, “personal care products” means products used in the cleaning, bleaching and/or disinfecting of hair, skin, scalp, and teeth, including, but not limited to shampoos, body lotions, shower gels, topical moisturizers, toothpaste, and/or other topical cleansers. In some particularly preferred embodiments, these products are utilized on humans, while in other embodiments, these products find use with non-human animals (e.g., in veterinary applications).

The following abbreviations may be used in the description. Definitions are also provided as needed throughout the description.

° C. degree Centigrade

Tm melting temperature

H₂O water

a_{w} water activity

Min minute

Hr hour

w/w weight/weight

wt % weight percent

g or gm grams

mM millimolar

Mg milligrams

Mg micrograms

mL and ml milliliters

μL and μl microliters

### Enzyme Granules

The granules provided herein are generally made up of a core, an enzyme layer containing one or more enzymes, and a pigment layer. In some embodiments, the granule comprises between 30-50% by total weight of the core, between about 10-30% or 15-25% by total weight of the one or more enzymes, and between about 5-15% by total weight of an aluminosilicate, such as a zeolite or kaolin.

In some embodiments, the enzyme granule provided herein is white or substantially white in color. In some embodiments, the enzyme granule has a Hunter color L value of from 50 to 100, preferably of from 60 to 90, more preferably of from 65 to 80.

The Hunter colored L value of the enzyme granule provided herein is measured as follows: A light source illuminates the surface of a sample and is reflected back to 3 filter-photocell detectors. The lightness and chromaticity or hue are measured and L, a, and b values assigned. The sample whose color is to be measured is placed in the sample container (70 mm diameter by 50 mm deep), and leveled at the top of this container before recording the Hunter color ‘L’ value using the ColorQuest Meter (ColorQuest-45/0, or equivalent).

In some embodiments, the disclosure provides a population of enzyme-containing granules, where at least about 50%, 60%, 70%, 80%, 85%, 90%, or 95% of the granules have a diameter of about 150 μm to about 300 μm, about 150 m to about 350 μm, about 150 μm to about 355 μm, about 180 μm to about 300 μm, about 180 μm to about 350 μm, about 210 μm to about 350 m, about 212 μm to about 355 μm, or about 180 μm to about 355 μm. In some embodiments, at least about 50%, 60%, 70%, 80%, 85%, 90%, or 95% of the granules have a diameter of any of about 150, 160, 170, 180, 190, 200, or 210 μm to any of about 250, 260, 270, 280, 290, 300, 310, 320, 330, 340, 350, or 355 μm.

### Pigment Layer

In one embodiment, the enzyme granules provided herein comprise at least one pigment layer that comprises an aluminosilicate, such as a zeolite or kaolin. In some embodiments, the pigment layer also comprises additional components, such as a water-soluble polymer and a surfactant. Surfactants for use in the pigment layer can be selected from the group of cationic surfactants, nonionic surfactants, anionic, and amphoteric surfactants, and mixtures thereof.

In some embodiments, the pigment layer comprising an aluminosilicate of the granule is the outer layer of the granule. In some embodiments, the outer layer comprises a zeolite, a water-soluble polymer, and a nonionic surfactant. In other embodiments, the outer layer comprises a kaolin, a water-soluble polymer, and a non-ionic surfactant.

In some embodiments, the pigment layer contains between about 50-90%, 60-80%, or 65-75% by weight of the aluminosilicate (e.g. zeolite or kaolin), between about 10-30%, 15-25%, or about 20-25% by weight of the water-soluble polymer and between about 1-15%, 2-13%, or 5-10% by weight of the surfactant, preferably a nonionic surfactant. In one embodiment, the pigment layer comprises between about 65-75% by weight of a zeolite or kaolin, between about 20-25% by weight of a water-soluble polymer, and between about 5-10% of a surfactant.

Zeolites are generally described as crystalline, hydrated aluminosilicates with a three-dimensional framework structure constructed of SiO₄ and AlO₄ tetrahedra linked through oxygen bridges. The tetrahedra of SiO₄ and AlO₄ are the primary building blocks; the combination of which leads to the so-called secondary building units such as 4-, 5-, and 6-rings, double 4-, 5-, and 6-rings, and so on. Depending on the structure type, zeolites contain regular channels or interlinked voids whose aperture diameters are in the microporous range, i.e. below 2 nm. These pores contain water molecules and the cations necessary to balance the negative charge of the framework. The cations, which are mobile and can be exchanged, are mainly alkali metal or alkaline-earth metal ions.

The International Union of Pure and Applied Chemistry (IUPAC) provided guidelines for specifying the chemical formula for zeolites (see, e.g., McCusker, L. B. et al. (2003) “Nomenclature of structural and compositional characteristics of ordered microporous and mesoporous materials with inorganic hosts (IUPAC recommendations 2001)” Microporous Mesoporous Mater. 58:3). In the simplest form, a general formula can be given as:

|M_{x/n}(H₂O)_{y}|[AlₓSi₍ₜ₋ₓ₎O₂ₜ]-LTA, wherein

the guest species are listed between the braces, i.e., “| |,” and

the host framework is listed between the brackets, i.e., “[ ],”

M represents a charge-balancing cation such as Na, K, Ca or Mg,

x is the number of framework Al atoms in the unit cell,

n is the cation charge,

y is the number of adsorbed water molecules,

t is the total number of framework tetrahedral atoms in the unit cell (Al+Si), and

LTA, herein entered as an example, is the code or the framework type.

In general, any zeolite may be used in the granules described herein. The preferred zeolites of the present disclosure include Erionite, Zeolite A, Zeolite P, Zeolite MAP, Zeolite X, Zeolite Y, Mordenite, Zeocros E110, and Zeocros CG180.

Kaolin, also sometimes referred to as kaolinite, is generally described as a clay mineral made up of a layered silicate mineral, with one tetrahedral sheet of silica linked through oxygen atoms to one octahedral sheet of alumina octahedral. The kaolin for use in the compositions and methods provided herein include both natural and synthetic kaolin.

In some embodiments, the pigment layer further comprises a polymer, a surfactant, and optionally additional components.

In some embodiments, the pigment layer does not comprise titanium dioxide.

In some embodiments, the pigment layer is coated over the enzyme layer. In another embodiment, the pigment coating layer is coated over a barrier layer, which is coated over the enzyme layer.

### Enzyme Layer

The enzyme layer may contain one or more enzymes. The enzyme layer may also contain one or more of a polymer, a sugar, a starch, and a surfactant.

The present compositions and methods are applicable to many different enzymes. Exemplary enzymes include acyl transferases, α-amylases, β-amylases, arabinosidases, aryl esterases, carrageenases, catalases, cellobiohydrolases, cellulases, chondroitinases, cutinases, nucleases (such as DNases and RNases), endo-β-1,4-glucanases, endo-beta-mannanases, esterases, exo-mannanases, galactanases, α-galactosidases, β-galactosidases, β-glucanases, glucoamylases, hemicellulases, hyaluronidases, keratinases, laccases, lactases, ligninases, lipases, lipoxygenases, mannanases, oxidases, oxidoreductases, pectate lyases, pectin acetyl esterases, pectinases, pentosanases, perhydrolases, peroxidases, peroxygenases, phenoloxidases, phosphatases, phospholipases, phytases, polygalacturonases, proteases, pullulanases, reductases, rhamnogalacturonases, tannases, transglutaminases, xylan acetyl-esterases, xylanases, xyloglucanases, xylosidases, metalloproteases, proteases, and combinations, thereof.

Examples of proteases include but are not limited to subtilisins, such as those derived from Bacillus (e.g., subtilisin, lentus, amyloliquefaciens, subtilisin Carlsberg, subtilisin 309, subtilisin 147 and subtilisin 168), including variants as described in, e.g., U.S. Pat. No. RE 34,606, U.S. Pat. Nos. 5,955,340, 5,700,676, 6,312,936, and 6,482,628, all of which are incorporated herein by reference. Additional proteases include trypsin (e.g., of porcine or bovine origin) and the Fusarium protease described in WO 89/06270. In some embodiments the protease is one or more of MAXATASE®, MAXACAL™, MAXAPEM™, OPTICLEAN®, OPTIMASE®, PROPERASE®, PURAFECT®, PURAFECT® OXP, PURAMAX™, EXCELLASE™, PURAFAST™, EXCELLENZ® P, and EFFECTENZ® P (DuPont Industrial Biosciences); ALCALASE®, SAVINASE®, PRIMASE®, DURAZYM™, POLARZYME®, OVOZYME®, KANNASE®, LIQUANASE®, NEUTRASE®, RELASE®, ESPERASE®, BLAZE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan). Additional proteases are described in WO95/23221, WO 92/21760, WO 09/149200, WO 09/149144, WO 09/149145, WO 11/072099, WO 10/056640, WO 10/056653, WO 11/140364, WO 12/151534, WO2016/205755 U.S. Pat. Publ. No. 2008/0090747, and U.S. Pat. Nos. 5,801,039, 5,340,735, 5,500,364, 5,855,625, U.S. RE 34,606, U.S. Pat. Nos. 5,955,340, 5,700,676, 6,312,936, and 6,482,628.

Proteases include neutral metalloproteases including those described in WO 07/044993 and WO 09/058661. Other exemplary metalloproteases include nprE, the recombinant form of neutral metalloprotease expressed in Bacillus subtilis (see e.g., WO 07/044993), and PMN, the purified neutral metalloprotease from Bacillus amyloliquefacients.

Lipases include, but are not limited to Humicola lanuginosa lipase (see e.g., EP 258 068, and EP 305 216), Rhizomucor miehei lipase (See e.g., EP 238 023), Candida lipase, such as C. antarctica lipase (e.g., the C. antarctica lipase A or B; See e.g., EP 214 761), Pseudomonas lipases such as P. alcaligenes lipase and P. pseudoalcaligenes lipase (see e.g., EP 218 272), P. cepacia lipase (See e.g., EP 331 376), P. stutzeri lipase (See e.g., GB 1,372,034), P. fluorescens lipase, Bacillus lipase (e.g., B. subtilis lipase (Dartois et al. (1993) Biochem. Biophys. Acta 1131:253-260); B. stearothermophilus lipase (see e.g., JP 64/744992); and B. pumilus lipase (see e.g., WO 91/16422)).

Additional lipases include Penicillium camembertii lipase (Yamaguchi et al. (1991) Gene 103:61-67), Geotricum candidum lipase (See, Schimada et al. (1989) J. Biochem. 106:383-388), and various Rhizopus lipases such as R. delemar lipase (Hass et al. (1991) Gene 109:117-113), a R. niveus lipase (Kugimiya et al. (1992) Biosci. Biotech. Biochem. 56:716-719) and R. oryzae lipase. Additional lipases are the cutinase derived from Pseudomonas mendocina (See, WO 88/09367), and the cutinase derived from Fusarium solani pisi (WO 90/09446). Various lipases are described in WO 11/111143, WO 10/065455, WO 11/084412, WO 10/107560, WO 11/084417, WO 11/084599, WO 11/150157, and WO 13/033318. In some embodiments the lipase is one or more of M1 LIPASE™, LUMA FAST™, LIPOMAX™ and PREFERENZ® L 100 (DuPont Industrial Biosciences); LIPEX®, LIPOLASE® and LIPOLASE® ULTRA (Novozymes); and LIPASE P™ “Amano” (Amano Pharmaceutical Co. Ltd., Japan).

Amylases include, but are not limited to those of bacterial or fungal origin, or even mammalian origin. Numerous suitable are described in WO9510603, WO9526397, WO9623874, WO9623873, WO9741213, WO9919467, WO0060060, WO0029560, WO9923211, WO9946399, WO0060058, WO0060059, WO9942567, WO0114532, WO02092797, WO0166712, WO0188107, WO0196537, WO0210355, WO9402597, WO0231124, WO9943793, WO9943794, WO2004113551, WO2005001064, WO2005003311, WO0164852, WO2006063594, WO2006066594, WO2006066596, WO2006012899, WO2008092919, WO2008000825, WO2005018336, WO2005066338, WO2009140504, WO2005019443, WO2010091221, WO2010088447, WO0134784, WO2006012902, WO2006031554, WO2006136161, WO2008101894, WO2010059413, WO2011098531, WO2011080352, WO2011080353, WO2011080354, WO2011082425, WO2011082429, WO2011076123, WO2011087836, WO2011076897, WO94183314, WO9535382, WO9909183, WO9826078, WO9902702, WO9743424, WO9929876, WO9100353, WO9605295, WO9630481, WO9710342, WO2008088493, WO2009149419, WO2009061381, WO2009100102, WO2010104675, WO2010117511, WO2010115021, WO2013184577, WO9418314, WO2008112459, WO2013063460, WO0115028, WO2009061380, WO2009100102, WO2014099523, WO2015077126A1, WO2013184577, WO2014164777, PCT/US12/70334, PCT/US13/74282, PCT/CN2013/077294, PCT/CN2013/077134, PCT/CN2013/077137, PCT/CN2013/077142, PCT/CN2012/087135, PCT/US12/62209, PCT/CN2013/084808, PCT/CN2013/084809, and PCT/US14/23458. Commercially available amylases include, but are not limited to one or more of DURAMYL®, TERMAMYL®, FUNGAMYL®, STAINZYME®, STAINZYME PLUS®, STAINZYME ULTRA®, AMPLIFY®, ACHIEVE ALPHA® and BAN™ (Novozymes), as well as POWERASE™, RAPIDASE® and MAXAMYL® P, PREFERENZ® S100, PREFERENZ® S110, and PREFERENZ® S1000 (DuPont Industrial Biosciences).

Cellulases include but are not limited to those having color care benefits (see e.g., EP 0 495 257). Examples include Humicola insolens cellulases (See e.g., U.S. Pat. No. 4,435,307) and commercially available cellulases such as CELLUZYME®, CAREZYME® (Novozymes), and KAC-500(B)™ (Kao Corporation), and PRIMAFAST® GOLD, REVITALENZ® (DuPont). In some embodiments, cellulases are incorporated as portions or fragments of mature wild-type or variant cellulases, wherein a portion of the N-terminus is deleted (See e.g., U.S. Pat. No. 5,874,276). Additional suitable cellulases include those found in WO2005054475, WO2005056787, U.S. Pat. Nos. 7,449,318, and 7,833,773.

Mannanases are described in U.S. Pat. Nos. 6,566,114, 6,602,842, 5, 476, and 775, 6,440,991, and U.S. Patent Application No. 61/739,267, all of which are incorporated herein by reference). Commercially available include, but are not limited to MANNASTAR®, PURABRITE™, PREFERENZ® M, and MANNAWAY®.

Nucleases for use in the compositions and methods provided herein include DNases and RNases. Exemplary nucleases include, but are not limited to, those described in WO2015181287, WO2015155350, WO2016162556, WO2017162836, WO2017060475 (e.g. SEQ ID NO: 21), WO2018184816, WO2018177936, WO2018177938, WO2018/185269, WO2018185285, WO2018177203, WO2018184817, WO2019084349, WO2019084350, WO2019081721, WO2018076800, WO2018185267, WO2018185280, WO2018206553, and WO2019/086530. Other nucleases which can be used in the compositions and methods provided herein include those described in Nijland R, Hall M J, Burgess J G (2010) Dispersal of Biofilms by Secreted, Matrix Degrading, Bacterial DNase. PLoS ONE 5(12) and Whitchurch, C. B., Tolker-Nielsen, T., Ragas, P. C., Mattick, J. S. (2002) Extracellular DNA required for bacterial biofilm formation. Science 295: 1487.

In some embodiments, peroxidases are used in combination with hydrogen peroxide or a source thereof (e.g., a percarbonate, perborate or persulfate) in the compositions of the present teachings, to the extent possible. In some alternative embodiments, oxidases are used in combination with oxygen. Both types of enzymes are used for “solution bleaching” (i.e., to prevent transfer of a textile dye from a dyed fabric to another fabric when the fabrics are washed together in a wash liquor), preferably together with an enhancing agent (See e.g., WO 94/12621 and WO 95/01426). Suitable peroxidases/oxidases include, but are not limited to those of plant, bacterial or fungal origin. Chemically or genetically modified mutants are included in some embodiments.

Perhydrolases include the enzyme from Mycobacterium smegmatis. This enzyme, its enzymatic properties, its structure, and numerous variants and homologs, thereof, are described in detail in International Patent Application Publications WO 05/056782A and WO 08/063400A, and U.S. Patent Publications US2008145353 and US2007167344, which are incorporated by reference. In some embodiments, the Mycobacterium smegmatis perhydrolase, or homolog, includes the S54V substitution.

Other perhydrolases include members of the carbohydrate family esterase family 7 (CE-7 family) described in, e.g., WO2007/070609 and U.S. Patent Application Publication Nos. 2008/0176299, 2008/176783, and 2009/0005590. Members of the CE-7 family include cephalosporin C deacetylases (CAHs; E.C. 3.1.1.41) and acetyl xylan esterases (AXEs; E.C. 3.1.1.72). Members of the CE-7 esterase family share a conserved signature motif (Vincent et al., J. Mol. Biol., 330:593-606 (2003)).

Other perhydrolase enzymes include those from Sinorhizobium meliloti, Mesorhizobium loti, Moraxella bovis, Agrobacterium tumefaciens, or Prosthecobacter dejongeii (WO2005056782), Pseudomonas mendocina (U.S. Pat. No. 5,389,536), or Pseudomonas putida (U.S. Pat. Nos. 5,030,240 and 5,108,457).

The enzyme layer may also optionally include one or more other components in addition to the one or more enzyme(s). Such non-enzyme components include, but are not limited to, polymers (e.g., polyvinyl alcohol, polyethylene glycol), sugars (e.g., sucrose, saccharose, glucose, fructose, galactose, maltodextrin), starches (e.g., corn starch, wheat starch, tapioca starch, potato starch, chemically or physically modified starch), dextrins, antifoam agents (e.g., polyether polyols such as Foamblast 882 (Emerald Foam Control), Erol DF 204K (Ouvrie PMC), DG436 (ODG Industries, Inc.), KFO 880 (KABO Chemicals, Inc.)), sugar alcohols (e.g., sorbitol, maltitol, lactitol, xylitol), surfactants (e.g., alcohol ethoxylates such as Neodol 23-6.5 (Shell Chemical LP, Houston, Tex.) and Lutensol TO65 (BASF)), and anti-redeposition agents (e.g., polyethylene glycol polyesters such as Repel-o-Tex SRP6 (Rhodia, Inc.), Texcare SRN-100 or SRN-170 (Clariant GmbH, Sorez-100 (ISP Corp.)). In some embodiments, the enzyme layer contains a water soluble polymer, such as polyvinyl alcohol or polyethylene glycol.

### Core

The granules provided herein generally also comprise a core, consisting of one or more inorganic salts. In some embodiments, the core consists of sodium sulfate, sodium citrate, sodium chloride, calcium sulfate, or a combination thereof. In one embodiment, the core consists of sodium sulfate.

The core of the granules provided herein generally has a diameter of about 100 um to about 250 um, about 150 um to about 250 um, or about 250 um to about 300 um.

### Detergent Compositions

The granules provided herein find use in the preparation of compositions containing the enzyme granules, which may be subsequently formed into powders, tablets or other unit dose forms of detergent. Such compositions may contain components suitable for use of the granules in particular applications, such as for use in cleaning (e.g. detergents), textiles, or animal feed.

In some embodiments, enzyme-containing granules as described herein are incorporated into a cleaning composition, such as a detergent, e.g., for laundry or dishwashing use, to provide cleaning performance and/or cleaning benefits. Enzymes suitable for inclusion in a cleaning composition include, but are not limited to, hemicellulases, peroxidases, proteases, cellulases, xylanases, lipases, phospholipases, esterases, cutinases, pectinases, keratinases, reductases, oxidases, phenoloxidases, lipoxygenases, ligninases, pullulanases, tannases, pentosanases, malanases, ß-glucanases, arabinosidases, hyaluronidase, chondroitinase, laccases, perhydrolases, and amylases, or mixtures thereof. A typical combination is a cocktail of conventional applicable enzymes like protease, lipase, cutinase and/or cellulase in conjunction with amylase.

Adjunct materials may also be included in the cleaning composition, for example, to assist or enhance cleaning performance, for treatment of the substrate to be cleaned, or to modify the aesthetics of the cleaning composition as is the case with perfumes, colorants, dyes or the like. It is understood that such adjuncts are in addition to the enzyme-containing granules as 5 described herein. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, deposition aids, dispersants, enzyme stabilizers, catalytic materials, bleach activators, bleach boosters, preformed peracids, polymeric dispersing agents, clay soil removal/anti-redeposition agents, brighteners, suds suppressors, dyes, perfumes, structure elasticizing agents, fabric softeners, carriers, hydrotropes, processing aids and/or pigments.

A cleaning composition as described herein may comprise a surfactant or surfactant system wherein the surfactant can be selected from nonionic surfactants, anionic surfactants, cationic surfactants, ampholytic surfactants, zwitterionic surfactants, semi-polar nonionic surfactants, and mixtures thereof. A surfactant is typically present at a level of about 0.1% to about 60%, about 1% to about 50% or about 5% to about 40% by weight of the subject cleaning composition.

A cleaning composition as described herein may further comprise one or more detergent builder or builder system. When a builder is used, the subject cleaning composition will typically comprise at least about 1%, about 3% to about 60%, or about 5% to about 40% builder by weight of the subject cleaning composition.

Builders that may be used in the cleaning compositions provided herein include, but are not limited to, the alkali metal, ammonium and alkanolammonium salts of polyphosphates, alkali metal silicates, alkaline earth and alkali metal carbonates, aluminosilicate builders, polycarboxylate compounds, ether hydroxypolycarboxylates, copolymers of maleic anhydride with ethylene or vinyl methyl ether, 1, 3, 5-trihydroxy benzene-2, 4, 6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

A cleaning composition as described herein may also contain one or more chelating agents. Suitable chelating agents include, but are not limited to, copper, iron and/or manganese chelating agents and mixtures thereof. When a chelating agent is used, the cleaning composition may comprise about 0.1% to about 15%, or about 3.0% to about 10% chelating agent by weight of the subject cleaning composition. Suitable cleaning agents include, but are not limited to, sodium salts of glutamic acid diacetic acid (GLDA), and methylglycinediacetic acid (MGDA).

A cleaning composition as described herein may contain one or more deposition aid. Suitable deposition aids include, but are not limited to, polyethylene glycol, polypropylene glycol, polycarboxylate, soil release polymers such as polytelephthalic acid, and clays such as Kaolinite, bentonite, montmorillonite, atapulgite, illite, bentonite, halloysite, and mixtures thereof.

A cleaning composition as described herein may include one or more dye transfer inhibiting agent. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones, and polyvinylimidazoles, and mixtures thereof. When present in a subject cleaning composition, dye transfer inhibiting agent may be present at levels of about 0.0001% to about 10%, about 0.01% to about 5%, or about 0.1% to about 3% by weight of the cleaning composition.

A cleaning composition as described herein may also contain one or more dispersants. Suitable water-soluble organic dispersants include, but are not limited to, the homo- or co-polymeric acids or their salts, in which the polycarboxylic acid comprises at least two carboxyl radicals separated from each other by not more than two carbon atoms.

Enzymes for use in cleaning compositions can be stabilized by various techniques. Enzymes employed herein can be stabilized, for example, by the presence of water-soluble sources of calcium and/or magnesium ions in the finished compositions that provide such ions to the enzymes.

A cleaning composition as described herein may further include one or more catalytic metal complex. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra (methylenephosphonic acid) and water-soluble salts thereof. Such catalysts are disclosed in U.S. Pat. No. 4,430,243. Manganese-containing catalysts useful herein are known, and are described, for example, in U.S. Pat. No. 5,576,282. Cobalt bleach catalysts useful herein are known, and are described, for example, in U.S. Pat. Nos. 5,597,936 and 5,595,967. Such cobalt catalysts are readily prepared by known procedures, such as taught for example in U.S. Pat. Nos. 5,597,936 and 5,595,967

The compositions provided herein may also include a transition metal complex of a macropolycyclic rigid ligand—abbreviated as “MRL”. As a practical matter, and not by way of limitation, the compositions and cleaning processes herein can be adjusted to provide on the order of at least one part per hundred million of the active MRL species in the aqueous washing medium, and will often provide about 0.005 ppm to about 25 ppm, about 0.05 ppm to about 10 ppm, or about 0.1 ppm to about 5 ppm, of the MRL in the wash liquor. Suitable transition-metals in a transition-metal bleach catalyst include manganese, iron and chromium. In one embodiment, an MRL is an ultra-rigid ligand that is cross-bridged, such as 5,12-diethyl-1,5,8, 12-tetraazabicyclo[6.6.2] hexadecane. Suitable transition metal MRLs are readily prepared by known procedures, such as taught for example in PCT Application No. WO 00/332601 and U.S. Pat. No. 6,225,464.

The cleaning compositions disclosed herein of can be used to clean a site, including a stain, on a surface or fabric. In some embodiments, at least a portion of the site is contacted with a cleaning composition as described herein, in neat form or diluted in a wash liquor, and then the situs is optionally washed and/or rinsed. Washing includes, but is not limited to, scrubbing, and mechanical agitation. A fabric may comprise most any fabric capable of being laundered in normal consumer use conditions. The disclosed cleaning compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric mass ratio is typically from about 1:1 to about 30:1.

Examples of automatic dishwashing compositions that the enzyme granules provided herein can be used in, include those described in US20130130358, WO2017186579, U.S. Pat. No. 8,962,543, EP2885391, US20170022452, WO2018118745, and US20140018278.

### Methods

Also provided herein are cleaning methods employing the enzyme granules and compositions provided herein.

In one embodiment, methods for cleaning a surface are provided, wherein the method comprises contacting a surface with a cleaning composition comprising an enzyme granule having at least one pigment coating comprising between about 10%-30% of a water-soluble polymer, between about 1%-10% of a nonionic surfactant, and between about 60-90% of an aluminosilicate.

In some embodiments, the surface to be cleaned in such methods are any surface in need of cleaning. In some embodiments, the surface to be cleaned is a fabric, dish or hard surface.

In another embodiment, methods are provided for reducing the spotting and filming on a dish or hard surface in an automatic dishwasher. Such methods comprise contacting or dish or hard surface with an automatic dishwashing composition having an enzyme granule comprising a core, an enzyme layer and a pigment layer, where the pigment layer contains at least a water-soluble polymer, a nonionic surfactant, and an aluminosilicate, such as a zeolite or kaolin. In some embodiments, the methods provided reduce spotting and filming at least about 10%, 20%, 30%, 35%, 40%, 45%, 50%, 55%, 60%, 65%, 70%, 75%, 80%, 85%, 90%, 95% or more compared to methods utilizing enzyme granules containing conventional pigments, such as titanium dioxide.

In another embodiment, there is provided a method for reducing filming and spotting on a hard surface in an automatic dishwasher using the composition of the disclosure. Such methods comprise contacting a hard surface with an automatic dishwashing composition having an enzyme granule comprising a core, an enzyme layer and a pigment layer, where the pigment layer comprises an aluminosilicate, such as a zeolite or kaolin. Such methods may utilize multi-cycle conditions, in some aspects, more than 2 cycles, more than 10 cycles, or more than 20 cycles.

The following examples are provided to demonstrate and illustrate certain preferred embodiments and aspects of the present disclosure and should not be construed as limiting.

### EXAMPLES

### Example 1: Enzyme Granule

An exemplary formulation for a batch of granules, produced using a fluid-bed spray process, is shown below in Table I. The initial spray in this example was applied to sodium sulfate crystals charged into a fluid-bed chamber, and suspended therein. The enzyme used was a B. gibsonii clade Bgi02446 variant subtilisin as described in WO2016205755 (Genencor International, Inc.). In this and the following examples, “spray 1” denotes an enzyme matrix formed on a fluidizable particle, “spray 2” denotes the barrier matrix, and “spray 3” denotes the pigment coating of the present invention. Certain details of the fluid-bed process were substantially as described in Example 2 of WO 99/32613, incorporated herein by reference.

### TiO2 Enzyme Granule Formulation

| | | |
|---|---|---|
| core | Na2SO4 seed (Na-GIII | 31.0% |
| | EE, feed) | |
| SP1-1 | Enzyme | 39.49% |
| SP1-2 | PVAS (20%) | 1.8% |
| SP2 | Na2SO4 30% | 16.41% |
| SP3 | PPNA (17.5%) | 11.0% |
| SP4 | Lutensol Overcoat | 0.3% |
| | Total composition/mass | 100.0% |
| | yield | |

### Zeolite Enzyme Granule Formulation

| | Component | Component Payload |
|---|---|---|
| SP1 | Enzyme Solids | 38.53% |
| | PVA | 4.00% |
| SP2 | Na2SO4 | 5.00% |
| SP3 | Zeolite (Zeocros | 14.00% |
| | CB180 or E110) | |
| | PVA | 4.50% |
| | Neodol | 1.40% |
| SP4 | Neodol | 0.00% |
| Core | Na2SO4 | 32.57% |

### Kaolin Enzyme Granule

| | Component | Component Payload |
|---|---|---|
| SP1 | Enzyme Solids | 34.23% |
| | PVA | 4.00% |
| SP2 | Na2SO4 | 5.00% |
| SP3 | Ultex 96 | 14.00% |
| | PVA | 4.50% |
| | Neodol | 1.40% |
| SP4 | Neodol | 0.00% |
| Core | Na2SO4 | 36.87% |

### Example 2: Effect of Aluminosilicate Pigment Layer Granules in ADW Application

### Test 1 Filming Test

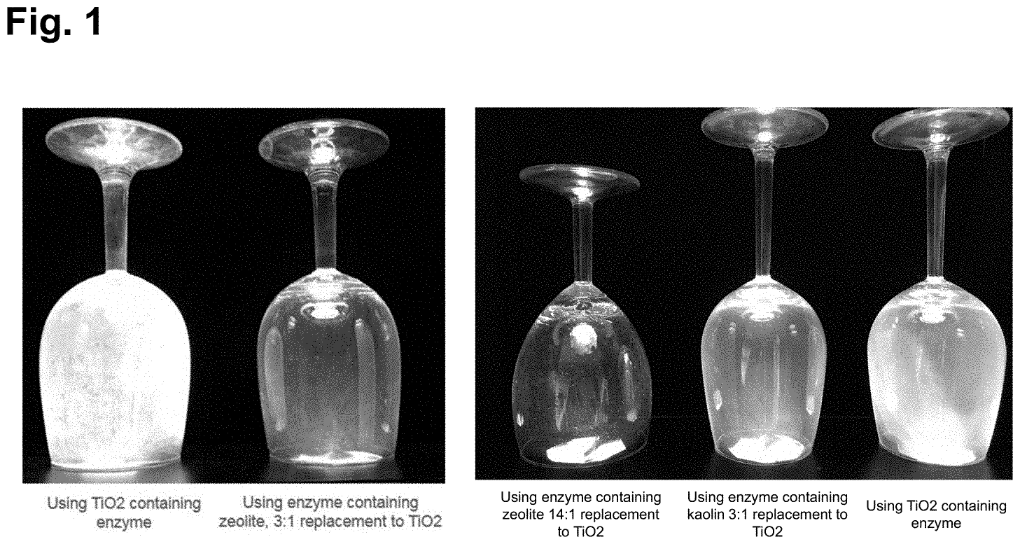

The effect of synthetic zeolite or kaolin pigment layer granules compared to TiO₂ to reduce film formation on glass was tested in an ADW application. In a filming/spotting test, a Miele GSL 1222 dishwasher was loaded with 6 wine glasses (Royal Leerdam Crystal, Leerdam The Netherlands) and washed for five consecutive washes. Enzyme granules containing either Zeolite, kaolin, or TiO₂ (20 g/wash) in the pigment layers were used for washing the glasses in the absence of any detergent or soil. Water hardness was set at 8.5° gH and the machine was run using the 65° C., 20′ program. The washed glasses were scored for severity of filming as described in ASTM standard D3556-85 (Reapproved 2009) (A score of 0 being no glass damage and 4 being strong damage, clearly visible). Score results are shown in Table 1. FIG. 1 shows reduced film on glass when washed with zeolite or kaolin containing enzymes compared to TiO2 containing enzymes.

TABLE 1
Filming/spotting test on wine glasses TiO2 containing
enzymes vs. Zeolite vs. Kaolin containing enzymes

| | | Using Zeolite | Using Zeolite | Using Kaolin |
|---|---|---|---|---|
| | TiO2 containing | replacing TiO2 at | replacing TiO2 at | replacing TiO2 at |
| | enzymes used [—] | 3:1 ratio [—] | 14:1 ratio [—] | 14:1 ratio [—] |
| average score | 4 | 1 | 3 | 3 |

### Test 2 Filming Test, Extended

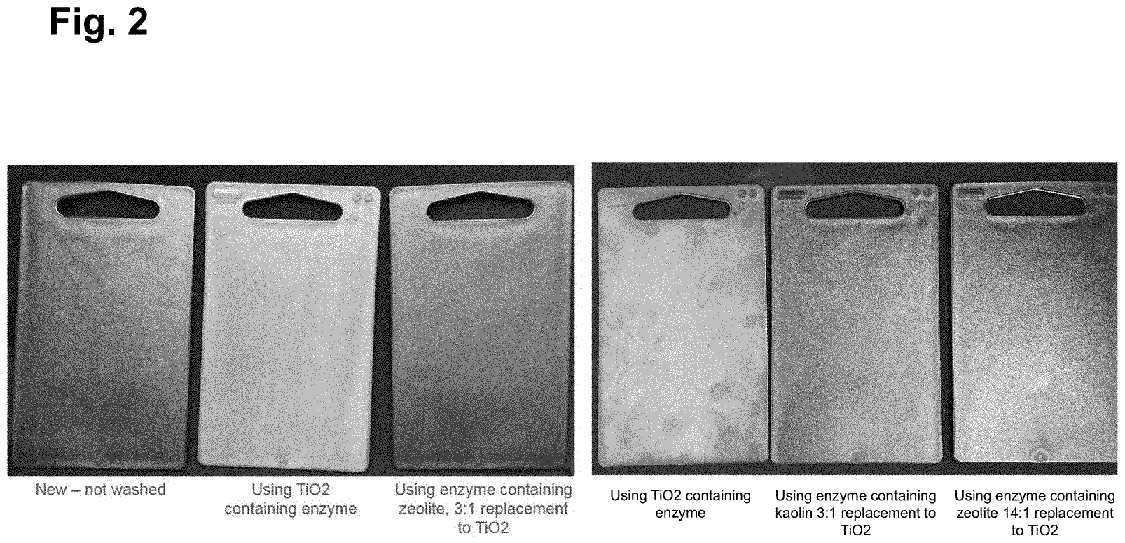

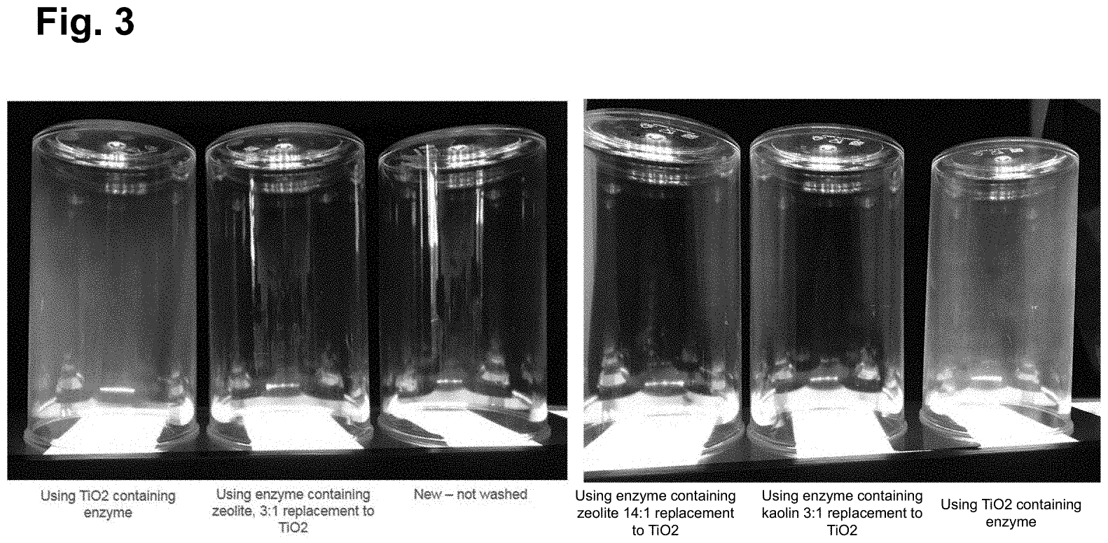

In this spotting/filming test, washing of black chopping board and transparent glass tube was tested using demineralized water so the effect of Ca²⁺ and Mg²⁺ ions on film forming would be eliminated. As in the previous test, cleaning was tested in the absence of any detergent or soil. Enzyme granules containing either Zeolite, kaolin, or TiO₂ (20 g/wash) pigment layers were used and the machine was run using the 45° C., 8′ program. The test consisted of 10 consecutive washes. Scoring for filming was done as described in Test 1. Score results for Test 2 are shown in Table 2. FIG. 2a shows reduced film formation on cutting board when washed with zeolite containing enzymes compared to TiO2 containing enzymes. FIG. 2b shows reduced filming on black chopping boards when washed with enzyme granules containing a pigment coating having kaolin compared to TiO2 granules. FIG. 3a shows reduced film formation on glass tubes when washed with zeolite containing enzymes compared to TiO2 containing enzymes. FIG. 3b shows reduced filming on glass tubes when washed with enzyme granules containing a pigment coating having kaolin compared to TiO2 granules. Similar results were obtained with plastic food containers washed with zeolite or kaolin containing granules compared to TiO2 containing granules (data not shown).

TABLE 2
Filming/spotting test on multiple articles
TiO₂ containing enzymes vs. Zeolite containing enzymes

| | | Using Zeolite | Using Zeolite | Using Kaolin |
|---|---|---|---|---|
| | TiO2 containing | replacing TiO₂ at | replacing TiO₂ at | replacing TiO₂ at |
| | enzymes used [—] | 3:1 ratio [—] | 14:1 ratio [—] | 3:1 ratio [—] |
| food container | 3 | 2 | 2 | 2 |
| black chopping | 4 | 0 | 0 | 0 |
| board | | | | |
| transparent tube | 3 | 1 | 2 | 1 |
| average score | 3.3 | 1.0 | 1.3 | 1.0 |

Compositions containing granules having Zeolite and kaolin pigment layers as provided herein showed reduced levels of filming and spotting on the articles tested compared to those containing TiO2.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A granule comprising a core and at least one layer, wherein the granule comprises:
a. at least one enzyme; and
b. at least one pigment coating comprising between about 10%-30% of a water soluble polymer, between about 1%-10% of a nonionic surfactant, and between about 60%-90% of an aluminosilicate, wherein the pigment coating does not contain titanium dioxide.

2. The granule of claim 1, wherein the enzyme is selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, DNase or nuclease, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, lysozymes, mannanases, oxidases, pectate lyases, pectin acetyl esterases, pectinases, pentosanases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, metalloproteases, nucleases, serine proteases, and combinations thereof.

3. The granule of claim 1, wherein the water soluble polymer is a polyvinyl polymer selected from the group consisting of PVP, PVA, and copolymers thereof.

4. The granule of claim 1, wherein the pigment coating comprises between about 15%-25% of a water soluble polymer.

5. The granule of claim 1, wherein the nonionic surfactant is an alcohol ethoxylate.

6. The granule of claim 1, wherein the pigment coating comprises between about 5%-10% of a nonionic surfactant.

7. The granule of claim 1, wherein the pigment coating comprises between about 60%-80% of an aluminosilicate.

8. The granule of any of the previous claims, wherein the aluminosilicate is selected from the group consisting of a zeolite and a kaolin.

9. A granule composition comprising,
a core,
an enzyme layer comprising at least one enzyme wherein the enzyme comprises between 10%-30% of the total granule composition; and
a pigment layer surrounding the enzyme layer, wherein the pigment layer comprises a water soluble polymer, a nonionic surfactant, and a zeolite, wherein the zeolite comprises between 5%-10% of the total granule composition, and
wherein the granule has a Hunter color L-value of greater than 50.

10. The granule composition of claim 9, wherein the granule has a Hunter color L-value of between 60-80.

11. The granule of claim 9, wherein the at least one enzyme is selected from the group consisting of acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, DNase or nuclease, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, lysozymes, mannanases, oxidases, pectate lyases, pectin acetyl esterases, pectinases, pentosanases, peroxidases, phenoloxidases, phosphatases, phospholipases, phytases, polygalacturonases, proteases, pullulanases, reductases, rhamnogalacturonases, beta-glucanases, tannases, transglutaminases, xylan acetyl-esterases, xylanases, xyloglucanases, xylosidases, metalloproteases, nucleases, serine proteases, and combinations thereof.

12. The granule of claim 9, wherein the water soluble polymer is a polyvinyl polymer selected from the group consisting of PVP, PVA, and copolymers thereof.

13. The granule of claim 9, wherein the pigment coating comprises between about 15%-25% of a water soluble polymer.

14. The granule of claim 9, wherein the nonionic surfactant is an alcohol ethoxylate.

15. The granule of claim 9, wherein the pigment coating comprises between about 5%-10% of a nonionic surfactant.

16. The granule of claim 9, wherein the pigment coating comprises between about 60-80% of an aluminosilicate.

17. The granule of claims 9-16, wherein the aluminosilicate is selected from the group consisting of a zeolite and a kaolin.

18. A method of cleaning a surface, the method comprising:
a. contacting a surface with a composition comprising a granule of any of claims 1-18; and
b. rinsing the surface.

19. The method of claim 18, wherein the surface is selected from a fabric, dish, or hard surface.

20. A method of reducing the filming and/or spotting on dishes washed in an automatic dishwasher comprising contacting the dishes with a dishwashing composition comprising:
a. an enzyme granule comprising:
i. a core;
ii. an enzyme layer comprising between 10%-30% of the total granule composition; and
iii. a pigment layer surrounding the enzyme layer, wherein the pigment layer comprises a water soluble polymer, a nonionic surfactant, and an aluminosilicate, wherein the aluminosilicate comprises between 5%-20% of the total granule composition, and
wherein the granule has a Hunter color L-value of greater than 50.

21. The method of claim 20, wherein the surface is selected from a dish or hard surface.

22. The granule of claims 20-21, wherein the aluminosilicate is selected from the group consisting of a zeolite and a kaolin.
